(19) United States
(12) Patent Application Publication
(10) Pub. No.: US 2024/0297791 A1
(43) Pub. Date: Sep. 5, 2024

(54) METHOD FOR FULLY RETRIEVING PASSWORDS WITHOUT PLAINTEXT STORAGE WITH VERIFICATION SYSTEM

(71) Applicant: EPITYON S.R.L.S., Verona (VR) (IT)

(72) Inventors: Tiziano TRESANTI, Pomarolo (TN) (IT); Andrea Eugenio NAIMOLI, Rovereto (TN) (IT); Raja MARAZZINI, Parabiago (MI) (IT)

(73) Assignee: EPITYON S.R.L.S., Verona (VR) (IT)

(21) Appl. No.: 18/573,027

(22) PCT Filed: Jun. 23, 2022
(86) PCT No.: PCT/IB2022/055824

§ 371 Date: Dec. 21, 2023

(30) Foreign Application Priority Data
Jun. 25, 2021 (IT) 102021000016706

(51) Int. Cl. H04L 9/32; H04L 9/06; H04L 9/08

(52) U.S. Cl. CPC H04L 9/3226; H04L 9/0643; H04L 9/085; H04L 9/3247

(57) ABSTRACT

The present invention relates to a method and a system for fully retrieving a password without the need for storing in plaintext the same by decomposing the information into any number of distributable portions on several subjects or devices and with a system for verifying the retrieval.

The present invention relates to a method and a system for fully retrieving a password without the need for storing the same in plaintext by decomposing the information into any number of distributable portions on several subjects or devices and with a system for verifying the retrieval.

### BACKGROUND

In order to safeguarding digital data, there are many protection methods substantially based upon access control (properly said “authentication”) and upon encoding in case even with combined encryption systems (or simply “encryption”: during the storing step there is the real encryption, whereas in the data retrieving step there is the “decryption” inverse one). In the second case, information can be used only by decrypting them and in case of network systems this may occur on the user side (“client” side) so that plaintext data are never available on devices out of control of the user itself.

For the authentication and encryption/decryption steps different recognition systems (mnemonic with pin or password, biometric, other . . . from which hereinafter “accreditation systems” or “accreditation”) are used, which usually provide retrieving or restoring methods for emergency situations; in all these cases an alternative identification method (an alternative “channel”) has to be provided in order to be able to perform the possible restoring only by the authorized subject.

### Accreditation and Password Reset

The accreditation systems may be always supported by a secondary system based upon an alphanumeric password (for example, this occurs in almost all access systems on mobile devices in which usually it is compulsory to set a password of this kind as alternative access to other methods, such as the biometric ones).

In case of a simple access control, it is possible to implement “password reset” systems therefore through the alternative channel the authorized subject is identified and a new password is created (for example this occurs in the web systems in which a unique link is sent with time limit on an e-mail address recorded by the user to create a new access password).

In case of encryption system, no restoring system analogous to the previous one is possible since for the decryption step it is necessary to have available a well precise password and it is not possible to create a new different one thereof.

The present invention defines a method for fully retrieving a password which can be used in any context and in particular in those in which the full retrieving is required as in the information encryption systems.

It is further to be noted that any protection system can by kept in a super system keeping it and which can be managed through a password thereto the present invention is to be applied: this is the case of “password manager” software usable to group several access instruments to several information sets (even with protection methods different to each other). Generally, however, the protection systems can be brought back to digital sequences which may be considered as passwords (for example a common “digital certificate” is nothing but a digital content consisting of a sequence of bytes and displayable directly or indirectly—through simple encoding—as alphanumeric sequence, and thus even for other protection systems): at the limit it is always possible to represent such sequences as alphanumeric strings by using the hexadecimal representation of the bytes constituting them.

In the description of the invention the term “super password” is used to represent an alphanumeric password or any digital information for accessing protected data as described above which can even be enriched with additional meta-information as specified hereinafter.

### Technical Problem Solved by the Invention

The object of the present invention is to manage a super password of an owner user (hereinafter “owner”) for information protected through it so that:
1. the storage is secure: it is to be meant that should not be any immediate method to be able to have access to such information, but there should be only a method requiring knowledge, actions, abilities or skills—or combinations of the previous ones—of the owner and that are hardly accessible by third parties
2. the retrieval is possible fully: the owner has to be able to retrieve fully the super password in a simple way
3. the retrieval can be verified: it has to be possible to verify the retrieval procedure independently from the use of the super password (then by analysing the information of such step and not trivially trying to use the super password itself).

About the above-illustrated problems, the present invention faces and solves important limitations of the state of art thereamong:
1. storage: if the information is stored in one single place this piece of information is kept in plaintext locally or protected with an encryption system. In the first case the direct access to the storage place bypasses any protection (for example this is the case of a password stored in plaintext on a server, for an administrator who can enter directly on the server itself), whereas in the second case it simply moves the problem on safeguarding the encryption system (then, the problem remains unsolved). In the present invention the information can be decomposed into several distributable parts at will having the following features:
   1.1. it is necessary to reunite several parts—and not necessarily all of them, but a sub-set of cardinalities, at owner's choice, lower than or equal to that of the set of all parts—in order to be able to retrieve the super password
   1.2. the single parts are not correlatable to each other and they cannot trace back to the super password: there is no direct information allowing to associate several parts to each other, except in case a general heading apart from the cunning device described hereinafter. The only procedure with secure detectable effects is the recomposition one requiring to have a set as the one indicated in point 1.1
   1.3. having a set of parts as the one indicated in point 1.1 a process is applied leading to the retrieving of the super password (and it is possible to verify that such process is successful, see also the following points).
2. retrieval: by having available a correct set of parts, the recomposition procedure has to be simple and immediate
3. verification: by applying a suitable recomposition process to a set of parts if they are correlated but in not sufficient amount or they belong to sets of different origin, no information is obtained, nor even useful for a situation analysis (for example it is not possible to understand if it is the case of an insufficient amount of parts or of not correlated parts). This point is very important: for example, let's consider a system of encrypted and protected data which requires to enter a decryption code: upon entering, data are decrypted and analysed so as to verify if decryption was successful (for example by controlling if the format is correct or with some additional control code) and one counts the decryption attempts so that may be after 3 failed consecutive attempts the data are removed. In a context of this kind, it is fundamental that once the retrieving of the super password is performed this is certainly the valid one, considering that a direct use for checking would not be possible considering the risk of losing the data themselves.

Ultimately, the verification system is based upon the quality and effectiveness of hashing function: in general, it is designated that there is “reasonable” certainty on the process validation with reference to such effectiveness, considering that—as known—hashing functions can potentially generate conflicts among data (that is they can return the same “hash” value with different starting data: however, this is a rare event by choosing suitable hashing functions as per subsequent examples).

### Process of the Invention

The invention defines two complementary processes called of “decomposition” and “recomposition” such that given a super password p and two integers at choice n and t such that 2≤t≤n through decomposition one reaches to obtain a set of parts or components (hereinafter even only “components”) of cardinality n such that given any sub-set of such components of cardinality at least t it is possible through recomposition to obtain the super password p.

The process is such that by applying the recomposition to a sub-set of components of cardinality lower than t or deriving from different decomposition procedures no useful information is obtained to deduce if the single components are or are not correlated to one another, whereas if it is successful according to the previous conditions the success can be verified.

Cases n=1 and t=1 are not taken into consideration since banal:
case n=1 (involving even t=1) indicates a decomposition in one single component: in this case there is simply a (in case transformed) copy of the super password and then the case is not interesting, among other things falling as particular case within the following.
cases n>1 and t=1 indicate a decomposition in which it is sufficient to have available one single component to reconstruct the super password: actually, it is simply a matter of having n (in case transformed) distributable copies. Even this case then is not interesting considering that it would involve the possibility for whoever has available one of the components to trace back to the super password.

Without losing generality they are considered variables representing digital information as sequences of bytes (integer comprised between 0 and 255 extremes included).

### Hereinafter:

the lowercase letters designate the “variables” (which represent data) and the uppercase ones the “functions”: the latter are algorithm procedures which given possible input parameters (designated hereinafter with name of the function in round brackets separated by comma) provide output data
the square brackets and a list of numbers designate the indicated sequences of bytes designate: for example [0, 234, 0] is the sequence of bytes 0, 234 and 0
the round brackets and a list of variables separated by comma designate the set of variables themselves: for example (a, b, c) is the set of variables a, b and c
the angle brackets and a list of variables designate the “juxtaposition” of variables: considering that each variable can be represented as sequence of bytes then <a, b> is the sequence which is obtained having at first the representation of a and then of b, then if a=[0, 255] and b=[255, 0] then <a, b>=[0, 255, 255, 0]
literal or numerical indices near variables and functions are used to better represent the elements.

Let's consider:
a super password p
an in case empty set of metadata d
two integers n and t such that 2≤t≤n
a pair of functions y=J_{E}(p, d) and (p, d)=J_{D}(y) which, given a super password and metadata, provide a combined representation thereof an vice versa (for example a serialization);
a pair of functions {yᵢ|i=1, . . . , n}=S_{E}(x, n, t) and x=S_{D}({yᵢ|i=1, . . . , t, . . . }) which, given a string x and the two integers n and t perform the decomposition and recomposition according to the already described specifications
a hashing function y=H(x) which given a string x returns a “signature” y (also called “hash”: with size typically defined much smaller than the input string)
two pairs of functions G_{E1}, Gp1 and G_{E2}, G_{D2} such that G_{E1} and G_{E2} given an input return an output and the corresponding G_{D1} and G_{D2} perform the inverse procedure, therefore if y=G_{E1}(x) then x=G_{D1}(y) and if y=G_{E2}(x) then x=G_{D2}(y)
a pair of functions y₁=M_{E}(x₁) and y₂=M_{D}(x₂), where one considers x₂=G_{E1}(H(z₂), G_{E2}(z₂) for some z₂, such that y₁=M_{E}(x₁)=G_{E1}(H(x₁), G_{E2}(x₁)) and y₂=M_{D}(x₂)=G_{D1}(x₂)=G_{D1}(G_{E1}(H(z₂), G_{E2}(z₂))) that is y₂=(H(z₂), G_{E2}(z₂)) and then one sets x₀=G_{E2}(z₂): then one considers the pair (H(z₂), H(G_{D2}(G_{E2}(z₂))))=(H(z₂), H(G_{D2}(z₂)) that is (H(z₂), H(x₀)) and then the two arguments can be compared to each other: if they are equal then one returns as output value of M_{D} function exactly x₀ otherwise one returns an error or a conventional value to represent such condition (for example “0”, or zero)
a 12-byte long string, a string r=[rₐ, r_{b}, r_{c}, r_{d}] and a pair of functions y₁=A_{E}(a, r, x₁) and y₂=A_{D}(x₂) such that A_{E}(a, r, x₁)=<a, r, x> and <a, r, x>=A_{D}(x₂). In particular, the string r represents the punctual choice of the functions applied in the decomposition step and to be applied in the recomposition step, whereas a is an identifying prefix. In substance <a, r> is a form of “heading” which applies to data x.

Given a, p, d, n, t ed r the passages indicated hereinafter for decomposition and recomposition are applied.

### Decomposition:

$$1. {q}_{1} = {J}_{E} ( p , d )$$

$$2. {q}_{2} = {M}_{E} ( {q}_{1} )$$

$$3. {q}_{3} = \{ {y}_{i} \vert i = 1 , … , n \} = {S}_{E} ( {q}_{2} , n , t )$$

$$4. {q}_{4 , i} = {A}_{E} ( a , r , {y}_{i} )$$

The various elements q_{4,i} (with i integer from 1 to n including extremes) are the distributable components.

### Recomposition:

(taken a set of at least t elements q_{4,i})

$$1. < a , r , , {y}_{i} > = {A}_{D} ( {q}_{4 , i} )$$

$$2. {q}_{3} = {S}_{D} ( \{ {y}_{i} \vert i = 1 , … , t , … \} )$$

$$3. {q}_{2} = {M}_{D} ( {q}_{3} )$$

$$4. {q}_{1} = {J}_{D} ( {q}_{2} )$$

Peculiarities of the functions used in the process.
The functions J_{E} and J_{D} are simply functions to manage the representation of data (for example from a “raw” to a structured format), for example a “json” encoding may be used.
The functions S_{E} and S_{D} have to be functions of a scheme of cryptographic secret-sharing with power equivalent to Shamir scheme (Shamir's Secret Sharing).
Hashing function H my be any hashing function (given a string with arbitrary length it returns a string with determined length; output strings with considerable differences correspond to similar input strings; it is difficult, once given a hash, that is a possible function output, to calculate a possible input therefore by applying the function such hash is obtained; it possibly has few conflicts, that is given two different inputs the same hash is hardly obtained)
The functions G_{E1}, G_{D1} and G_{E2}, G_{D2} can be even very simple.

The single components in case have in common only the 4 bytes corresponding to r, but this is no way limiting considering that the part related to a can be managed at will and then it can be used to create an additional protection layer by applying an additional information manipulation if desired. Moreover, by considering r as representative of the selection of the functions used in the two processes, there could be several combinations “compatible” to each other. In particular, if one wants to remove any correlation reference, one can simply not to store the heading of 16 bytes and use a “default” scheme. However, it is to be considered that such heading does not depend upon the origin data but only upon the punctual selection of the functions so it is common to several decomposition actions with different origin data.

As reference model and by way of example the following selections are used, by confirming that any equivalent power selection is possible:
a=“asuperpasswd”, r=[1, 0, 1, 1]
the json” encoding for the functions J_{E} and J_{D}
“Shamir” scheme (Shamir's Secret Sharing) for the functions S_{E} and S_{D}
SHA-256 hash function for function H
the two-digit “hex” encoding for G_{E2} and G_{D2}: in particular G_{E2} given a sequence of bytes, it returns the hexadecimal string representing it (for example [0, 15] becomes “000F” and vice versa)
the concatenation for G_{E1} and G_{D1} wherein one considers having only two elements the first one thereof having fixed length equal to that of the selected hash function: for example, y=G_{E1}(a, b)=<a, b> whereas G_{D1}(y) returns as a the first 32 bytes (length of the above-selected SHA-256 hash) of y and as b the remaining part (it is indeed assumed having only two arguments)

For the decomposition the process with the performed selections is applied. For the recomposition the first step is performed which is sure by obtaining, among other things, the value of r, which is used as reference to know which functions are to be applied in the subsequent passages. Such correspondence-apart from the above proposed specific example—can be defined externally in case even with the definition of a standard certificate.

A practical application is represented hereinafter by way of example with the above-shown options.

### ADVANTAGES OF THE INVENTION

Other advantages, together with the features and use modes of the present invention, will result evident from the following detailed description of preferred embodiments thereof, shown by way of example and not for limitative purposes.

Reference is made to the selections of the previous paragraph by having:
a=“asuperpasswd”, r=[1, 0, 1, 1], p=“Ciao”, n=5, t=3, d=( )

The “json” representation of the information is coded as:
{“password”: p, “data”: d} (d is an empty set)

so there is:
{“password”: “Ciao”, “data”: { }

### Decomposition:

1. q₁=“{“password”: “Ciao”, “data”: { }”
2. q₂=“3f60f2c2cff3d615b36cec558020ff7d434b2992987e0b2738d25c33cd 7943d5{“password”: “Ciao”, “data”: { }”
3. q_{3,1}=“8641dd97babe240c9e06ff7b7540c23dda53fcabd99e51d15113776 42edaf2396 db44a9467442e4f22dbc1ba7ab7ee3fb11dbd2582976f40941a 8d9e6fdca1dc701d63d162125443bf3ef1dda9eccd21505a0917a4cf15082 4bae1313538cc932aef”
   q_{3,2}=“8641dd97babe240c9e06ff7b7540c23dda53fcabd99e51d15113776 42edaf2396 db44a9467442e4f22dbc1ba7ab7ee3fb11dbd2582976f40941a 8d9e6fdca1dc701d63d162125443bf3ef1dda9eccd21505a0917a4cf15082 4bae1313538cc932aef”
   q_{3,3}=“8641dd97babe240c9e06ff7b7540c23dda53fcabd99e51d15113776 42edaf2396 db44a9467442e4f22dbc1ba7ab7ee3fb11dbd2582976f40941a 8d9e6fdca1dc701d63d162125443bf3ef1dda9eccd21505a0917a4cf15082 4bae1313538cc932aef”
   q_{3,4}=“8641dd97babe240c9e06ff7b7540c23dda53fcabd99e51d15113776 42edaf2396 db44a9467442e4f22dbc1ba7ab7ee3fb11dbd2582976f40941a 8d9e6fdca1dc701d63d162125443bf3ef1dda9eccd21505a0917a4cf15082 4bae1313538cc932aef”
   q_{3,5}=“8641dd97babe240c9e06ff7b7540c23dda53fcabd99e51d15113776 42edaf2396 db44a9467442e4f22dbc1ba7ab7ee3fb11dbd2582976f40941a 8d9e6fdca1dc701d63d162125443bf3ef1dda9eccd21505a0917a4cf15082 4bae1313538cc932aef”
4. q_{4,1}=“asuperpasswd10118641dd97babe240c9e06ff7b7540c23dda53fca bd99e51d1511377642edaf2396 db44a9467442e4f22dbc1ba7ab7ee3fb11 dbd2582976f40941a8d9e6fdca1dc701d63d162125443bf3ef1dda9eccd21 505a0917a4cf150824bae1313538cc932aef′
   q_{4,2}=“asuperpasswd10118641dd97babe240c9e06ff7b7540c23dda53fca bd99e51d1511377642edaf2396 db44a9467442e4f22dbc1ba7ab7ee3fb11 dbd2582976f40941a8d9e6fdca1dc701d63d162125443bf3ef1dda9eccd21 505a0917a4cf150824bae1313538cc932aef”
   q_{4,3}=“asuperpasswd10118641dd97babe240c9e06ff7b7540c23dda53fca bd99e51d1511377642edaf2396 db44a9467442e4f22dbc1ba7ab7ee3fb11 dbd2582976f40941a8d9e6fdca1dc701d63d162125443bf3ef1dda9eccd21 505a0917a4cf150824bae1313538cc932aef”
   q_{4,4}=“asuperpasswd10118641dd97babe240c9e06ff7b7540c23dda53fca bd99e51d1511377642edaf2396 db44a9467442e4f22dbc1ba7ab7ee3fb11 dbd2582976f40941a8d9e6fdca1dc701d63d162125443bf3ef1dda9eccd21 505a0917a4cf150824bae1313538cc932aef
   q_{4,5}=“asuperpasswd10118641dd97babe240c9e06ff7b7540c23dda53fca bd99e51d1511377642edaf2396 db44a9467442e4f22dbc1ba7ab7ee3fb11 dbd2582976f40941a8d9e6fdca1dc701d63d162125443bf3ef1dda9eccd21 505a0917a4cf150824bae1313538cc932aef

Recomposition with two (not sufficient) components only:

by using only the components q_{4,4} and q_{4,5} there is:
1. <a, r, y₄>=<“asuperpasswd”, [1, 0, 1, 1], “8641dd97babe240c9e06ff7b754 0c23dda53fcabd99e51d1511377642edaf2396 db44a9467442e4f22dbc1b a7ab7ee3fb11dbd2582976f40941a8d9e6fdca1dc701d63d162125443bf3e f1dda9eccd21505a0917a4cf150824bae1313538cc932aef″> <a, r, y₄>=<“asuperpasswd”, [1, 0, 1, 1], “8641dd97babe240c9e06ff7b7540 c23dda53fcabd99e51d1511377642edaf2396 db44a9467442e4f22dbc1ba 7ab7ee3fb11dbd2582976f40941a8d9e6fdca1dc701d63d162125443bf3ef 1dda9eccd21505a0917a4cf150824bae1313538cc932aef″>
2. q₃=[121, 205, 219, 172, 31, 124, 134, 102, 131, 49, 22, 250, 89, 211, 129, 97, 4, 242, 134, 102, 90, 137, 42, 4, 165, 42, 184, 222, 141, 168, 111, 232, 132, 101, 33, 241, 157, 153, 28, 253, 61, 98, 225, 90, 174, 126, 121, 128, 50, 33, 120, 150, 173, 72, 246, 223, 202, 94, 226, 109, 36, 152, 241, 12, 251, 142, 201, 95, 197, 60, 112, 250, 85, 212, 255, 138, 146, 182, 42, 1, 237, 112, 83, 83, 182, 36, 158, 69, 198, 159, 45, 146, 192, 171, 216, 109, 130, 10]
3. q₂=0
4. q₁=null: p=?, d=?

Recomposition with three (sufficient) components:

by using only the components q_{4,1} and q_{4,2} and q_{4,3} there is:
1. <a, r, y₁→=<“asuperpasswd”, [1, 0, 1, 1], “8641dd97babe240c9e06ff7b754 0c23dda53fcabd99e51d1511377642edaf2396 db44a9467442e4f22dbc1b a7ab7ee3fb11dbd2582976f40941a8d9e6fdca1dc701d63d162125443bf3e f1dda9eccd21505a0917a4cf150824bae1313538cc932aef″> <a, r, y₂>=<“asuperpasswd”, [1, 0, 1, 1], “8641dd97babe240c9e06ff7b754 0c23dda53fcabd99e51d1511377642edaf2396 db44a9467442e4f22dbc1b a7ab7ee3fb11dbd2582976f40941a8d9e6fdca1dc701d63d162125443bf3e f1dda9eccd21505a0917a4cf150824bae1313538cc932aef″> <a, r, y₃>=<“asuperpasswd”, [1, 0, 1, 1], “8641dd97babe240c9e06ff7b754 0c23dda53fcabd99e51d1511377642edaf2396 db44a9467442e4f22dbc1b a7ab7ee3fb11dbd2582976f40941a8d9e6fdca1dc701d63d162125443bf3e f1dda9eccd21505a0917a4cf150824bae1313538cc932aef″>
2. q₃=“3f60f2c2cff3d615b36cec558020ff7d434b2992987e0b2738d25c33cd 7943d5{“password”: “Ciao”, “data”: { }”
3. q₂=“{“password”: “Ciao”, “data”: { }”
4. q₁: p=“Ciao”, d=(empty set)

A convenient solution is that of an application of “password manager” with possibility of sharing the information among different users.

The application has server-side component which stores the information in wholly encrypted form and a client-side component which the single user uses to manage a portfolio of passwords: all encryption and decryption procedures occur on client side.

The application uses “anonymous” identifiers for the several users which can share between each other a part of the portfolio with other users with an exchange requiring a specific authorization for example with a mode analogous to that of pairing between bluetooth devices or by using a control code at choice. By referring to the latter case, a user could make “sharable” a piece of information for which it is requested to confirm data within a determined period of time with or without additional control according to the following steps:
the user X sends a sharing with the user Y so that a link has to be confirmed through a mailbox with “m” address
the user Y is notified of the sharing (this may occur in “automatic” way: the server may send a forewarning to all users by using the control field as encoding key and each user decodes the forewarning with the value of his/her own field, but only whoever has it correct will see the notification successfully) within a predetermined period of time: in case an additional control system can be urged (in this example a confirmation link may be sent to the e-mail box).

For accessing such portfolio (to store passwords and access codes for example on web sites, home-banking apps, e-mail boxes, etc.) a “super password” is set and additionally “n” and “t” parameters according to the scheme of the present invention. The super password then is subjected to the decomposition process and the single components are distributed on several users with the above-mentioned sharing system which may have an active role (if the additional control system activates) or may not have such role (without such control).

In case of need for retrieving such super password, a user may:
create a new “account” in the application
start a retrieving request: for the identification as owner several strategies may be used (in case even by combining them) such as for example:
   addition of a general information encoding layer through an encryption with asymmetric key wherein the public key remains available in the whole application (server side and in all involved clients), whereas the private one can be stored on several devices in which the user has the client of the application itself
   (preferable) one uses a distribution of the components between users known to the owner user which then has to be explicitly used during the retrieving step (for example the user X declares that the distribution has to occur by delivering the components to the users Y₁, . . . Y_{N} known to him/her and during the retrieving step he/she will have to specify a suitable subset of such users).

The present invention has been so far described with reference to preferred embodiments thereof. It is to be meant that each one of the technical solutions implemented in the preferred embodiments, herein described by way of example, can advantageously be combined, differently from what described, with the other ones, to create additional embodiments, belonging to the same inventive core and however all within the protective scope of the herebelow reported claims.

1. A computer implemented method for storing and retrieving digital information as pair (p, d), comprising the steps of:
converting a piece of digital information (p, d) from a pair of values to a unique value by a function for modifying the representation to obtain a modified digital information;
marking said modified digital information by affixing a signature based upon a hash function to obtain a modified and marked digital information;
decomposing of said modified and marked digital information into a number n≥2 of components (q_{3,1}, . . . , q_{3,n}), by exploiting a secret-sharing function such that it is possible to reconstruct the modified and marked digital information by using a subset of the components (g_{3,1}, . . . , q_{3,n}) of cardinality of at least t elements with t and n arbitrary integers and 2≤t≤n;
additional marking of each one of said components (q_{3,1}, . . . , q_{3,n}) with a signature representative of the specific functions used in the previous steps by obtaining to obtain a new set of distributable components (q_{4,1}, . . . , q_{4,n}).

2. The method according to claim 1, wherein the single distributable components (q_{4,1}, . . . , q_{4,n}) are not directly correlatable to each other.

3. The method according to claim 1, wherein the piece of digital information (p, d) comprises a password (p).

4. The method according to claim 3, wherein the piece of digital information (p, d) comprises a set of metadata (d).

5. The method according to claim 1, wherein said step of decomposing said digital information (p, d) comprises:
$$a ) {q}_{1} = {J}_{E} ( p , d )$$
$$b ) {q}_{2} = {M}_{E} ( {q}_{1} )$$
$$c ) {q}_{3} = \{ {y}_{i} \vert i = 1 , … , n \} = {S}_{E} ( {q}_{2} , n , t )$$
$$d ) {q}_{4 , i} = {A}_{E} ( a , r , {y}_{i} )$$
wherein
J_{E}(p, d) is a function which returns a combined representation of said piece of digital information (p, d);
M_{E}(q₁)=G_{E1}(H(q₁), G_{E2}(q₁)) wherein H(q₁) is a hashing function and G_{E1} and G_{E2} are two invertible functions for a change of information representation to make the modified and marked digital information suitable for storage or transmission for the subsequent steps;
S_{E}(q₂, n, t) is a function that performs the decomposing of q₂;
A_{E}(a, r, yᵢ) is a function, to be applied to each of the components (g_{3,1}, . . . , q_{3,n}), which given the input arguments outputs their unique representation given by the concatenation of the individual representations having a and r fixed length equal to 12 and 4 units.

6. The method according to claim 5, further comprising a step of recomposing said piece of digital information (p, d), which comprises:
$$a ) < a , r , , {y}_{i} > = {A}_{D} ( {q}_{4 , i} )$$
$$b ) {q}_{3} = {S}_{D} ( \{ {y}_{i} \vert i = 1 , … , t , … \} )$$
$$c ) {q}_{2} = {M}_{D} ( {q}_{3} )$$
$$d ) {q}_{1} = {J}_{D} ( {q}_{2} )$$
wherein:
A_{D}(q_{4,i}) is a function that divides input data into 3 elements considering the first 12 units as constituting the element a, the subsequent 4 units as constituting the element r and the remaining representation as constituting the element yᵢ; the element r is representative of the specific functions to be used in the following points;
S_{D}({yᵢ|i=1, . . . , t, . . . }) is a function that recomposes performs the recomposing of the modified and marked digital information using a secret-sharing function determined by r;
M_{D}(q₃)=G_{D1}(q₃) and it is assumed that q₃=G_{E1}(H(z₂), G_{E2}(z₂)) for some value z₂, for which M_{D}(q₃)=G_{D1}(q₃)=G_{D1}(G_{E1}(H(z₂), G_{E2}(z₂))) where H is a hashing function, G_{E1} and G_{E2} are two invertible functions whose inverses are respectively, G_{D1} and G_{D2}; the single specific functions are determined by r;
J_{D}(q₂) is a function, whose specificity is determined by r, which provides a representation of said piece of digital information (p, d) starting from the modified digital information q₂.

7. The method according to claim 6, wherein:
said J_{E} and J_{D} functions are JSON encoding/decoding functions;
said S_{E} and S_{D} functions are decomposition and recomposition functions according to Shamir's Secret Sharing algorithm;
said hashing function H is SHA-256 function;
said G_{E2} and G_{D2} functions implement a two-digit hexadecimal encoding/decoding;
said G_{E1} and G_{D1} functions are respectively the concatenation of a string having length equal to SHA-256 hash and of another one having arbitrary length and its inverse.

8. The method according to claim 1, further comprising storing each one of said distributable components (q_{4,1}, . . . , q_{4,n}) on media or devices distributed in a network.

9. A computer system comprising a client-side component and configured to implement a method for storing and retrieving digital information as pair (p, d), the client-side component configured to perform the steps of:
converting a piece of digital information (p, d) from a pair of values to a unique value by a function for modifying the representation to obtain a modified digital information;
marking said modified digital information by affixing a signature based upon a hash function to obtain a modified and marked digital information;
decomposing said modified and marked digital information into a number n>2 of components (g_{3,1}, . . . , q_{3,n}), by exploiting a secret-sharing function such that it is possible to reconstruct the modified and marked digital information by using a subset of the components (g_{3,1}, . . . q_{3,n}) of cardinality of at least t elements with t and n arbitrary integers and 2≤t≤n; and
additional marking of each one of said components (g_{3,1}, . . . , q_{3,n}) with a signature representative of the specific functions used in the previous steps to obtain a new set of distributable components (g_{4,1}, . . . , q_{4,n}).
